(19) United States
(12) Patent Application Publication
(10) Pub. No.: US 2026/0338551 A1
(43) Pub. Date: Oct. 29, 2026

(54) Laser Level

(71) Applicant: Milwaukee Electric Tool Corporation, Brookfield, WI (US)

(72) Inventors: David W. Draeger, Sussex, WI (US); Max D. Mutza, Pewaukee, WI (US)

(21) Appl. No.: 19/565,972

(22) Filed: Mar. 13, 2026

Related U.S. Application Data
(60) Provisional application No. 63/793,951, filed on Apr. 24, 2025.

(51) Int. Cl. G01C 15/00; G01C 9/12

(52) U.S. Cl. CPC G01C 15/004; G01C 9/12

(57) ABSTRACT

Various laser level designs are shown. In one example, the laser level is a multi-plane laser level that emits plane(s) out of a plurality of cage(s) and emits point(s). In various specific embodiments, the laser level is a three plane laser level that emits three planes and two points. The laser level includes a housing around a core. The core includes a pendulum and a beam splitter configured to emit two point beams. The core further includes one or more arms with a plane cone mirror assembly configured to emit a plane.

### CROSS-REFERENCE TO RELATED PATENT APPLICATION

The present application claims the benefit of and priority to U.S. Provisional Application No. 63/793,951, filed on Apr. 24, 2025, which is incorporated herein by reference in its entirety.

### BACKGROUND OF THE INVENTION

The present invention relates generally to the field of tools. The present invention relates specifically to a laser level such as a 3-plane laser level, a 2-point laser level or a combination laser level that projects one or more lasers planes and points onto a work piece or a work surface.

### SUMMARY OF THE INVENTION

One embodiment of the invention relates to a laser level including a housing and a core positioned within the housing. The core includes a support structure, a first arm, a second arm, a third arm, and a fourth arm. The first arm extends from the support structure and is configured to emit a first laser projection plane. The second arm extends from the support structure and is configured to emit a second laser projection plane. The third arm extends from the support structure and is configured to emit a third laser projection plane. The fourth arm extends from the support structure and is configured to emit a first laser point and a second laser point. The first laser point is collinear with the second laser point.

Another embodiment of the invention relates to a laser level including a housing and a core positioned within the housing. The core includes a support, a first arm, a second arm, a third arm, and a fourth arm. The first arm extends from the support and is configured to emit a first laser projection plane. The second arm extends from the support and is configured to emit a second laser projection plane. The third arm extends from the support and is configured to emit a third laser projection plane. The third arm has a generally horizontal orientation relative to the support. The fourth arm extends from the support in a generally horizontal orientation relative to the support and includes a beam splitter. A first angle defined between the fourth arm and the third arm is from 90 degrees to 135 degrees.

Another embodiment of the invention relates to a laser level including a housing and a core positioned within the housing. The core includes a support, a first arm, a second arm, a third arm, and a fourth arm. The first arm extends from the support and is configured to emit a first laser projection plane. The second arm extends from the support and is configured to emit a second laser projection plane. The third arm extends from the support and is configured to emit a third laser projection plane. The fourth arm extends from the support and is configured to emit a first laser point projection and a second laser point projection. A first angle is defined between the fourth arm and a second angle is defined between the fourth arm and the second arm. The second angle is the same as the first angle.

In a specific embodiment, the laser level further includes a bracket configured to support the housing. The housing is rotatable relative to the bracket about an axis of rotation. In a specific embodiment, the housing is rotatable between a first position and a second position.

Additional features and advantages will be set forth in the detailed description which follows, and will be readily apparent to those skilled in the art from the description or recognized by practicing the embodiments as described in the written description and/or shown in the accompanying drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a laser level emitting laser planes and points in a first position, according to an exemplary embodiment.

FIG. 2 is a perspective view of the laser level of FIG. 1 emitting laser planes and points in a second position, according to an exemplary embodiment.

FIG. 3 is a perspective view of the laser level of FIG. 1 with a support and power source removed, according to an exemplary embodiment.

FIG. 4 is a perspective view from below of the laser level of FIG. 1 with the support and power source removed, according to an exemplary embodiment.

FIG. 5 is a side view of the laser level of FIG. 1 with the support and power source removed, according to an exemplary embodiment.

FIG. 6 is a top view of the laser level of FIG. 1, according to an exemplary embodiment.

FIG. 7 is a perspective view of the laser level of FIG. 1 showing the internal components, according to an exemplary embodiment.

FIG. 8 is a perspective view of the laser level of FIG. 7 emitting laser planes and points with the housing removed, according to an exemplary embodiment.

FIG. 9 is a perspective view of the laser level of FIG. 7 with the housing removed, according to an exemplary embodiment.

FIG. 10 is a cross-sectional view of a plane cone mirror assembly taken along line 10-10 of FIG. 9, according to an exemplary embodiment.

FIG. 11 is a cross-section view of a point splitter assembly taken along line 11-11 of FIG. 9, according to an exemplary embodiment.

FIG. 12 is a top view of laser level core, according to an exemplary embodiment.

FIG. 13 is a top view of a laser level core, according to another exemplary embodiment.

### DETAILED DESCRIPTION

Referring generally to the figures, various embodiments of laser projection devices, are shown. As discussed herein, Applicant has developed an improved laser projection device that is configured to separately project three planes and two point lasers. As will be generally understood, many workers use different laser levels depending on the circumstances, specific applications, and user preferences. The use of separate three plane and two point laser device to accommodate different circumstances requires users to transport multiple laser devices to the work site and then switch between lasers for different tasks.

For example, on construction sites, a worker may find using a two point laser level easier for applications that require transferring a point on the floor to a point on the ceiling (e.g., hanging fixtures, installing plumbing, etc.). However, on the same construction site, a worker may find it more appropriate and/or efficient to use a three plane laser level for other tasks (e.g., leveling, grid installations such as for cabinets, aligning vertical surfaces for walls or posts, etc.). While a three plane laser level can be used to create a dot or point (e.g., where two planes cross on the floor) it can be difficult for a user to define the exact center of the intersection due to the brightness of the rest of the line impeding visibility of the intersection.

Applicant believes the laser levels discussed herein including a three plane laser level and a two point laser level improves work site efficiency. For example, workers will be able to switch between tasks suited to each type of laser level quickly without having to retrieve and set up a separate laser device. Further, by reducing the number of laser levels on a work site from two to one, Applicant believes interference between different laser devices is reduced.

In various embodiments, the laser levels discussed herein have a core that includes a fourth arm with a point splitter (e.g., configured to emit two points) and three arms including mirrors such as cone mirrors (e.g., configured to emit planes) and a self-leveling pendulum.

In a various embodiments, one of the arms extends vertically from the core while the second arm, third arm, and fourth arm extend generally horizontally. In a specific embodiment, the second arm extends at a 135 degree angle relative to the fourth arm. In a specific embodiments, the second arm and the third arm each extend at 135 degree angle relative to the fourth arm. Applicant believes such an arrangement provides the laser level with improved balance and a more compact size due to the fourth arm acting as a counterweight to the arms. In other words, the two point laser level (e.g., point splitter) having the plane components positioned at 135 in either direction allow for balance of the core without the need for a larger counterweight. In another specific embodiment, the fourth arm extends at a 90 degree angle relative to the second arm.

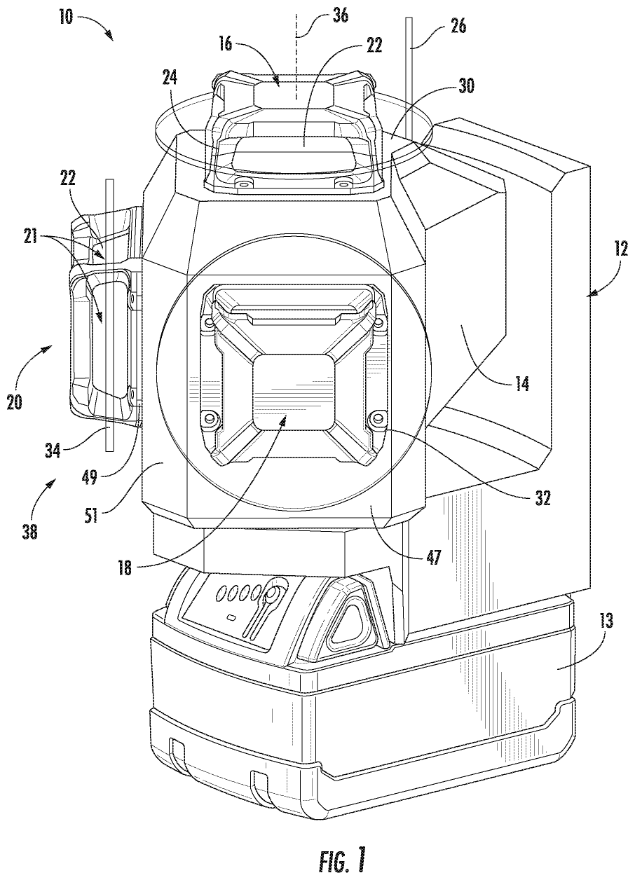

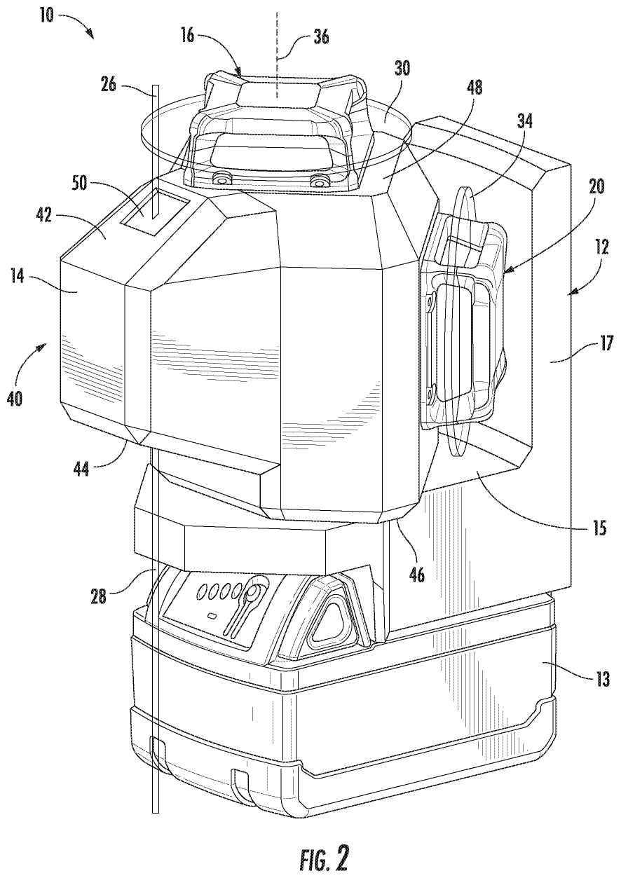

Referring to FIGS. 1-2, various aspects of a laser beam generating device shown as a laser level 10, are shown. In various specific embodiments, laser level 10 is a three plane laser and a two point laser. Laser level 10 includes a housing 14. In specific embodiments, laser level 10 includes a support, shown as a bracket 12. In various specific embodiments, bracket 12 is moveable to adjust a position of laser level 10 and/or housing 14. In various embodiments, bracket 12 includes a platform 15 and a wall 17. In such embodiments, platform 15 extends outward from wall 17 in a generally horizontal orientation (e.g., 90 degrees plus or minus 10 degrees). Housing 14 of laser level 10 is positioned on platform 15.

In specific embodiments, bracket 12 is fixed to housing 14 of laser level 10 by a fastener (e.g., screw, bolt, etc.). In specific embodiments, bracket 12 is an L-shaped bracket. In various embodiments, bracket 12 is a magnetic L-bracket. In specific embodiments, bracket 12 is a magnetic L-bracket with a magnetic component on and/or within wall 17. In other words, such a magnetic L-bracket 12 could be coupled magnetically to a magnetic surface (e.g., wall, etc.) to support laser level 10.

In various embodiments, laser level 10 includes a power supply, such as a battery. In specific embodiments, laser level 10 includes a power supply, such as a hand tool battery 13 coupled to bracket 12. In a specific embodiment, bracket 12 is positioned between battery 13 and housing 14 of laser level 10. In specific embodiments, battery 13 is a rechargeable lithium-ion battery. In other embodiments, the battery is positioned within the housing 14.

In various embodiments, laser level 10 includes one or more protective cages, shown as cage 16, 18, 20. In specific embodiments, laser level 10 includes a first cage 16, a second cage 18, and a third cage 20. In such an embodiment, each cage 16, 18, 20 is fixed to housing 14. In such an embodiment, a first plane 30 is associated with first cage 16, a second plane 32 is associated with second cage 18, and a third plane 34 is associated with third cage 20. In other words, a plane 30, 32, 34 will be projected out of each cage 16, 18, 20.

In various embodiments, laser level 10 further includes a two point laser with a first laser line or point projection 26 and a second laser line or point projection 28. As will be generally understood, projection 26 is collinear with projection 28. In specific embodiments, first laser point projection 26 and second laser point projection 28 are parallel to axis of rotation 36. Laser level 10 projects the laser line projections 26, 28 which appear as points on a work surface. In other specific embodiments, axis of rotation 36 is at an angle relative to a work surface and point projections 26, 28 are self-leveling. In specific embodiments, laser level 10 has an additional axis of rotation to allow for micro adjustment that is aligned to the cross of the two vertical laser lines.

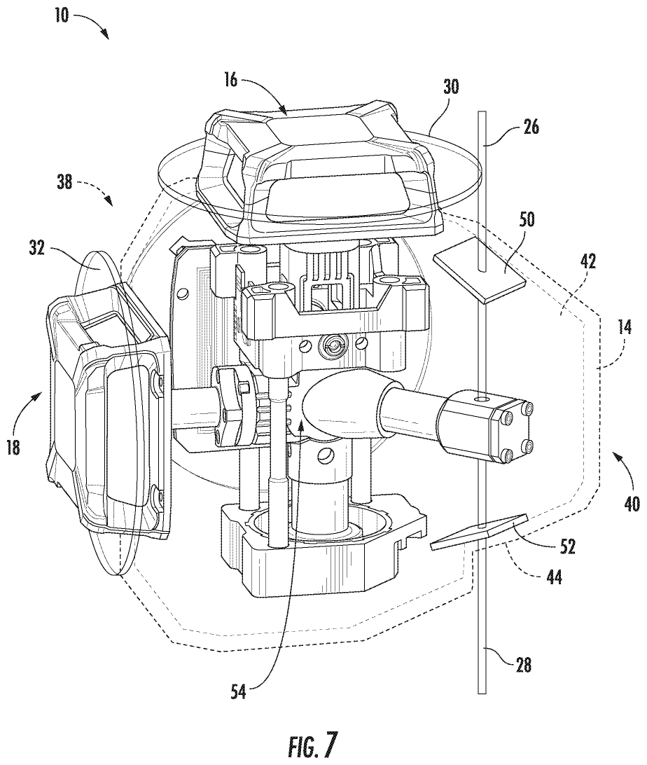

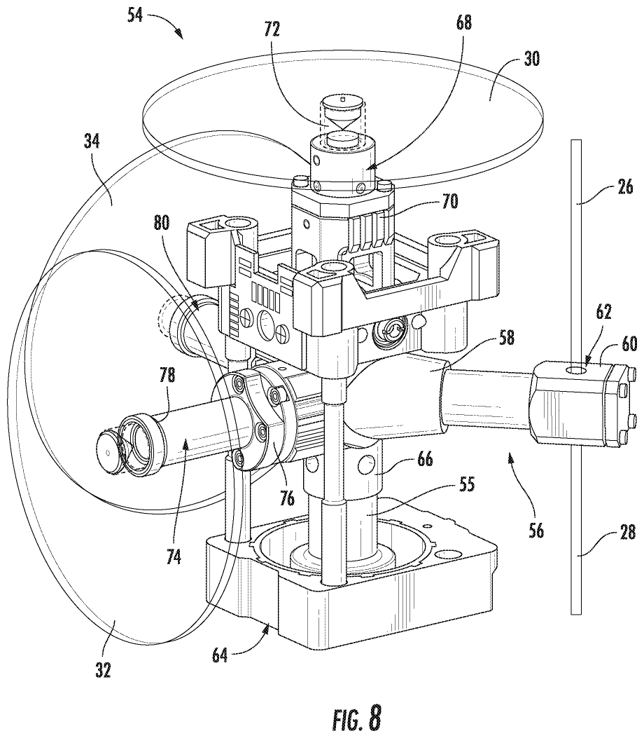

As will be discussed in greater detail below, in general, each cage 16, 18, 20 provides the space/area through which one or more component of laser core 54 (see e.g., FIG. 7) passes from housing 14 into a general space located within cage 16. In a specific embodiment, first plane 30 is a horizontal plane and second plane 32 and third plane 34 are each vertical planes (in the orientation shown in FIG. 1). In various specific embodiments, first cage 16 is positioned on an upward facing surface 48 of housing 14 (in the orientation shown in FIG. 2). Second cage 18 is positioned on a first side 47 surface of housing 14. Third cage 20 is positioned on a second side surface 49 of housing 14 that is different from the first side surface 47. In various embodiments, a front surface 51 is positioned between first side surface 47 and second side surface 49.

In various embodiments, cages 16, 18, 20 are fixedly or rigidly coupled to housing 14. In other words, cages 16, 18, 20 are non-rotationally coupled to housing 14. In such embodiments, cages 16, 18, 20 are fixedly coupled to housing 14 via fasteners (e.g., bolts, screws, etc.). It should be understood that the cages 16, 18, 20 could similarly be positioned on a different surface of the housing 14, projecting a vertical laser plane or a horizontal plane on the work surface.

In various embodiments, each cage 16, 18, 20 includes a frame 24 that defines a plurality of apertures or openings 21. In specific embodiments, the frame 24 includes legs that define the apertures 21. In a specific embodiment, the frame 24 includes four legs that define four apertures 21. In various embodiments, each cage 16, 18, 20 includes a plurality of windows 22 positioned within frame 24. In specific embodiments, each cage 16, 18, 20 includes four windows. As will be generally understood, the laser projection or laser projection plane 30, 32, 34 is projected through at least one of the plurality of apertures 21 or windows 22.

As shown in FIGS. 1-2, housing 14 of laser level is in a first, forward position. A front 38 of housing 14 is positioned in front or spaced from bracket 12 and specifically wall 17 of bracket 12. As will be generally understood, housing 14 is moveable about an axis of rotation 36. In a specific embodiment, axis of rotation 36 extends between upward facing surface 48 and downward facing surface 46 (see e.g., orientation in FIGS. 1-2) of housing 14. When a user would like to alter the positions of planes 30, 32, 34 and/or use the two point laser portion of laser level 10, housing 14 is moved about axis of rotation 36 into a second position.

As shown in FIG. 2, when a user would like to use the two point laser portion of laser level 10, housing 14 can be rotated such that rear 40 is facing away from bracket 12 (i.e., positioned further distance from bracket 12). When laser level 10 is in the first position, rear 40 faces toward bracket 12 (i.e., positioned adjacent or shorter distance from bracket 12) and specifically wall 17 of bracket 12. Rear 40 of laser level 10 and specifically housing 14 includes an upper angled surface 42 and a lower angled surface 44. A first window 50 is positioned on upper angled surface 42 and a second window 52 (see e.g., FIG. 4) is positioned on lower angled surface 44.

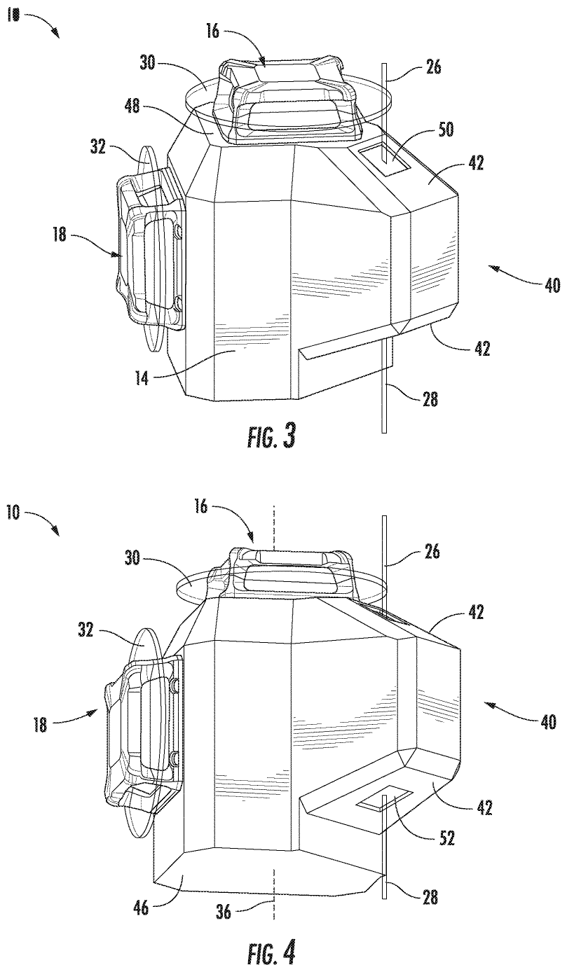

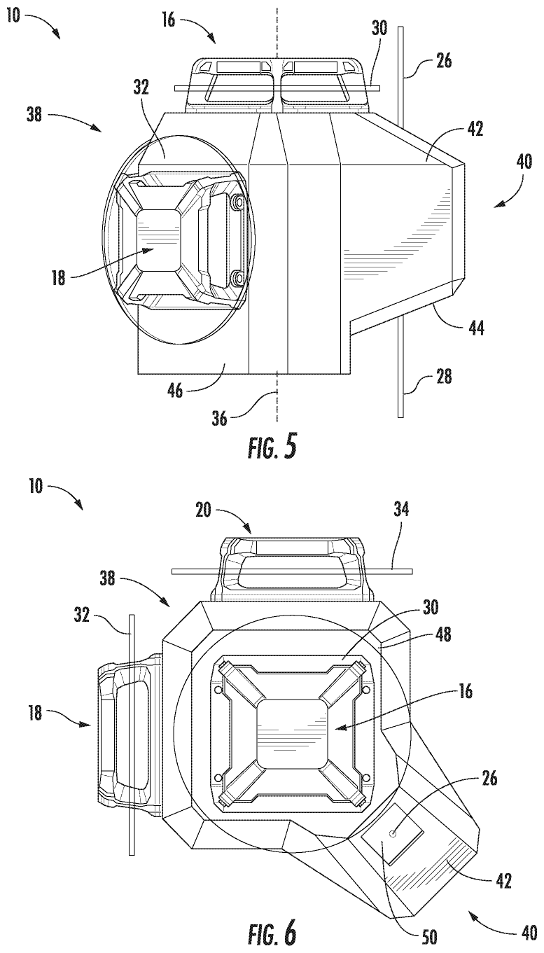

Referring to FIGS. 3-6, details of laser level 10 and specifically housing 14 are shown according to exemplary embodiments. First point 26 is projected through first window 50 and a second point 28 is projected through second window 52. First point projection 26 and second point projection 28 extend along a major or longitudinal axis of housing 14. As will be generally understood, first line projection 26 and second line projection 28 result in a point on a surface where the end of the respective projection 26, 28 engages with an object.

In specific embodiments, first point projection 26 and second point projection 28 are generally perpendicular (e.g., about 90 degrees plus or minus 5 degrees) to first plane 30. In a specific embodiments, first point projection 26 and second point projection 28 are about perpendicular (e.g., about 90 degrees plus or minus 65 arcsecond) to first plane 30. In specific embodiments, first point projection 26 and second point projection 28 have the same orientation as second plane 32 and third plane 34. In other words, in such embodiments, first point projection 26 and second point projection 28 extend vertically and planes 32 and 34 extend vertically.

As shown in FIG. 6, first plane 30 has a generally parallel orientation to upward facing surface 48. As will be understood, in specific embodiments first plane 30 is self leveling. In various embodiments, first plane 30 has a generally parallel orientation to downward facing surface 46. In a specific embodiment, first plane 30 has a generally parallel orientation to downward facing surface 46 and upward facing surface 48.

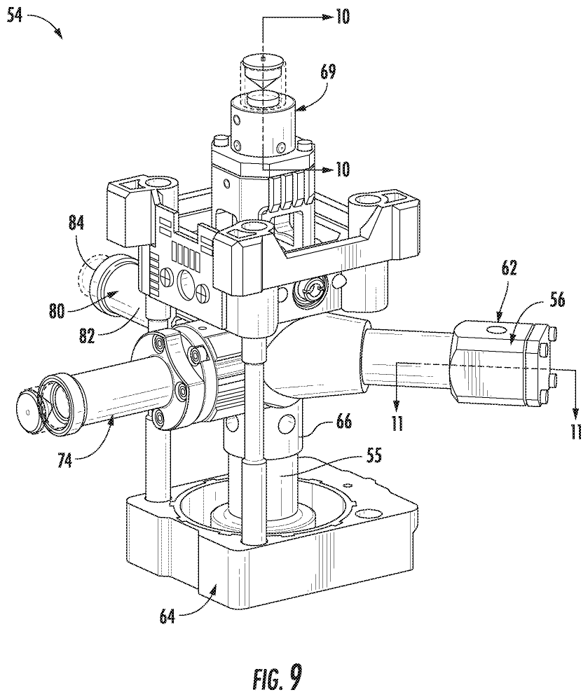

Referring to FIGS. 7-9, details of a core 54 of laser level 10 are shown according to exemplary embodiments. In general, a laser generator or core 54 (see e.g., FIG. 7) is positioned within housing 14. In general, laser core 54 includes various components for generating the laser line(s) or laser plane(s) associated with laser level 10, including one or more laser emitting device(s) (e.g. a laser diode etc.), various optical components (e.g., lens, collimators, mirrors, beam shapers, etc.) and supporting hardware (e.g. leveling pendulum, position sensors, electronic controllers, etc.). In other embodiments, laser level 10 includes two separate cores within housing 14. In other words, in some embodiments laser level 10 includes one core to generate the three-plane laser projections and a separate core to generate the two point laser projections.

In various embodiments, core 54 includes a support structure 64 and a component shown as vertical component 66 that extends upward from support structure 64. In a specific embodiment, vertical component 66 extends along axis of rotation 36. As will be understood, when laser level 10 is leveling, component 66 will be at an angle and not aligned with axis of rotation 36. As shown in FIG. 8, one or more arms 68, 74, 80 extend from vertical component 66. In a specific embodiment, three arms 68, 74, 80 extend from vertical component 66. In a specific embodiment, three arms 68, 74, 80 and a fourth arm 56 extend from vertical component 66. In various embodiments, a pendulum 55 is coupled to vertical component 66. In a specific embodiment, a pendulum 55 is positioned below vertical component 66. When the pendulum 55 is at rest, the pendulum 55 is generally vertical.

In various embodiments, the pendulum 55 is a self-leveling pendulum. In a specific embodiment, pendulum 55 has a gravity-based leveling system (e.g., series of shafts and bearings). As will be generally understood, in such embodiments, pendulum 55 floats freely in order to self-level based on gravity within an angular range (e.g., about 4 degrees). In other embodiments, pendulum 55 has an electronic leveling system. Such an electronic leveling system includes one or more bubble vials and photodiodes to determine a level position in a plurality of axes (e.g., x-axis, y-axis, z-axis). In other embodiments, the electronic leveling system includes accelerometers. In specific embodiments, a motor is used to level the core.

Fourth arm 56 includes a first end 58 coupled to vertical component 66 and an opposing second end 60. Second end 60 includes one or more bore(s) 62 configured to allow first point projection 26 and second point projection 28 to be projected outward from fourth arm 56.

In various embodiments, laser level 10 and specifically core 54 includes a first arm 68. In a specific embodiment, first arm 68 is collinear with vertical component 66. In various embodiments, first arm 68 extends along axis of rotation 36. In other embodiments, first arm 68 is offset from axis of rotation 36. First arm 68 extends between a first end 70 and an opposing second end 72. First end 70 is coupled to vertical component 66. First arm 68 is associated with first cage 16 and first plane 30.

Laser level 10 and/or core 54 further includes a second arm 74. Second arm 74 extends between a first end 76 and a second end 78. First end 76 is coupled to vertical component 66. In a specific embodiment, second arm 74 extends from vertical component 66 and has a horizontal orientation. In specific embodiments, second arm 74 is perpendicular to vertical component 66 and/or first arm 68. In specific embodiments, second arm 74 is parallel to pendulum 55. In other words, second arm 74 and pendulum 55 extend outward from vertical component 66 in the same orientation. Second arm 74 is associated with second cage 18 and second plane 32.

Laser level 10 and/or core 54 further includes a third arm 80. Third arm 80 extends between a first end 82 and a second end 84. First end 82 is coupled to vertical component 66. In a specific embodiment, third arm 80 extends from vertical component 66 and has a horizontal orientation. In specific embodiments, third arm 80 is generally perpendicular to vertical component 66 and/or first arm 68. In specific embodiments, third arm 80 is generally parallel to second arm 74. In other words, third arm 80 and second arm 74 each extend outward from vertical component 66 in the same orientation (e.g., generally horizontal). Third arm 80 is associated with third cage 20 and third plane 34.

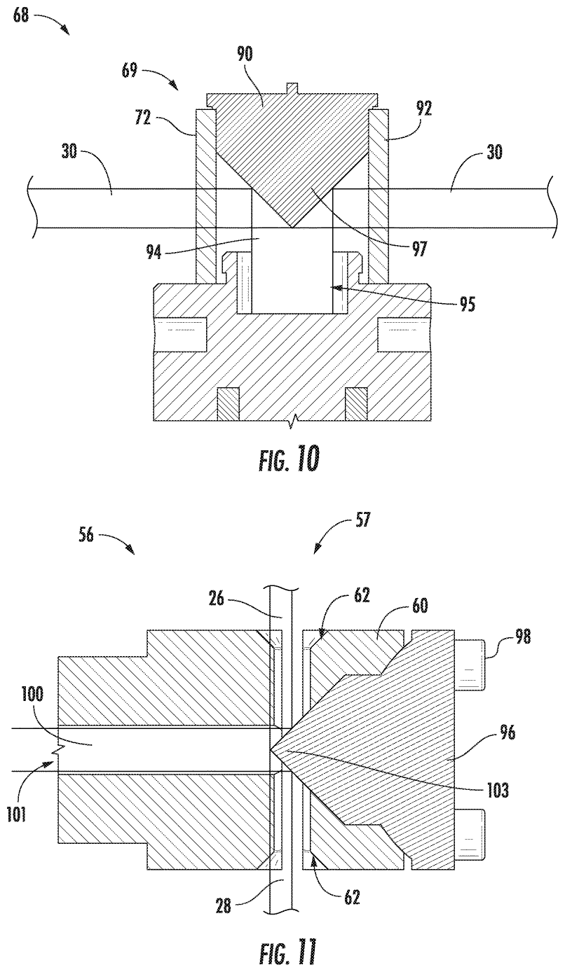

Referring to FIG. 10, a cross-sectional view of a plane cone mirror assembly 69 of first arm 68 is shown according to an exemplary embodiment. In a specific embodiment, a cone mirror 90 is positioned within cage 16 and a laser beam 94 generated by a laser diode within housing 14 and/or first end 70 is directed through an aperture 95 and centered on a tip 97 of cone mirror 90 to generate a projected laser plane 30. As will be generally understood, cone mirror 90 has a reflective surface that splits laser beam 94 in 360 degrees to create a full plane. Cone mirror 90 is positioned within a housing 92 at second end 72 of first arm 68. In various embodiments, second arm 74 and third arm 80 each include a cone mirror assembly that is substantially the same as first arm 68 to generate laser planes 32 and 34 respectively.

Referring to FIG. 11, a cross-sectional view of a beam or point splitter 57 of fourth arm 56 is shown according to an exemplary embodiment. In a specific embodiment, a mirror 96 is positioned within fourth arm 56 and specifically a housing 98 and a laser beam 100 generated by a laser diode within housing 14 and/or first end 76 is directed through an aperture 101 and centered on a tip 103 of mirror 96 to generate a first point projection 26 and a second point projection 28. In specific embodiments, mirror 96 is a right angle prism mirror (e.g., two reflective surfaces that meet at a right or 90 degree angle). As will be generally understood, the right angle prism mirror splits laser beam 100 into two linear directions two create the two points as previously discussed. Mirror 96 is positioned within the housing 92 at second end 60 of fourth arm 56.

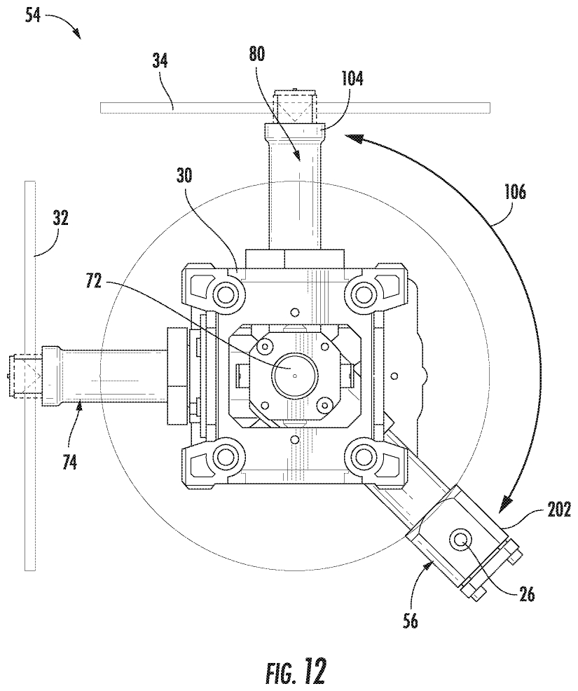

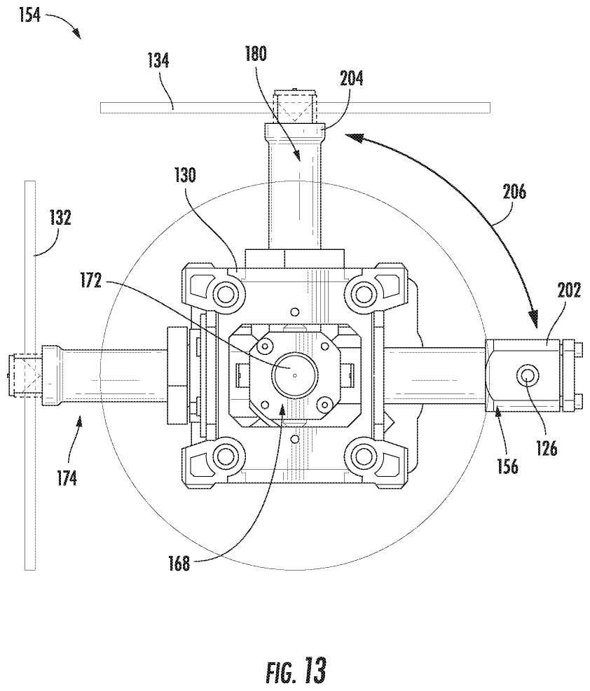

Referring to FIG. 12, a top view of core 54 is shown according to an exemplary embodiment. In various embodiments, fourth arm 56 includes a side surface 202 and third arm 80 includes a side surface 104. In various embodiments, an angle 106 is defined between fourth arm 56 and third arm 80. In specific embodiments, angle 106 is from 90 to 135 degrees, specifically from 100 to 135 degrees, and more specially 120 to 135 degrees. In a specific embodiment, angle 106 is about 135 degrees (e.g., 135 degrees plus or minus 10 degrees). In a specific embodiment, 90 degrees≤angle 106≤135 degrees.

In other words, in a specific embodiment, the third arm 80 extends at a 135 degree angle relative to the fourth arm 56. In a specific embodiment, the second arm 74 and the third arm 80 each extend at a 135 degree angle relative to the fourth arm 56. In other words, in various specific embodiments, a first angle defined between third arm 80 and fourth arm 56 and a second angle defined between second arm 74 and fourth arm 56 are the same. As previously discussed, Applicant believes such an arrangement of arms 74, 80 and 56 provides the laser level 10 with improved balance and/or weight due to the fourth arm 56 acting as a counterweight to the arms 74, 80.

Referring to FIG. 13, a top view of core 154 is shown according to an exemplary embodiment. Core 154 can be utilized with laser level 10. Core 154 is substantially the same as core 54 except for the difference discussed herein.

In various embodiments, fourth arm 156 includes a side surface 202 and third arm 180 includes a side surface 204. In various embodiments, an angle 206 is defined between fourth arm 156 and third arm 180. In specific embodiments, angle 206 is from 90 to 135 degrees, specifically from 90 to 120 degrees, and more specially from 90 to 100 degrees. In a specific embodiment, angle 206 is about 90 degrees (e.g., 90 degrees plus or minus 5 degrees). In a specific embodiment, 90 degrees≤angle 206≤135 degrees.

In other words, in a specific embodiment, the third arm 180 extends at a 90 degree angle relative to the fourth arm 156. In a specific embodiment, the second arm 174 extends at a 90 degree angle relative to second arm 174 and first arm 168. In a specific embodiment, second arm 174 is collinear with fourth arm 156.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A laser level comprising:
a housing; and
a core positioned within the housing, the core comprising:
a support structure;
a first arm extending from the support structure, the first arm configured to emit a first laser projection plane;
a second arm extending from the support structure, the second arm configured to emit a second laser projection plane;
a third arm extending from the support structure, the third arm configured to emit a third laser projection plane; and
a fourth arm extending from the support structure, the fourth arm configured to emit a first laser point and a second laser point, wherein the first laser point is collinear with the second laser point.

2. The laser level of claim 1, wherein the first arm extends vertically from the support structure, and wherein the second arm and the third arm each extend in a generally perpendicular orientation relative to the first arm.

3. The laser level of claim 1, further comprising a bracket configured to support the housing, wherein the housing is movable relative to the bracket about an axis of rotation.

4. The laser level of claim 3, wherein the first arm extends along the axis of rotation.

5. The laser level of claim 1, wherein the fourth arm further comprises a first end coupled to the support structure and a second end that opposes the first end, and wherein the second end comprises a right angle prism mirror.

6. The laser level of claim 1, wherein the first arm further comprises a first end coupled to the support structure and a second end that opposes the first end of the first arm, and wherein the second end of the first arm comprises a cone mirror.

7. The laser level of claim 1, wherein the core further comprises a pendulum coupled to the support structure.

8. The laser level of claim 7, wherein the pendulum is a self-leveling pendulum.

9. The laser level of claim 1, wherein an angle defined between the fourth arm and the third arm is about 135 degrees.

10. The laser level of claim 9, wherein an angle defined between the fourth arm and the second arm is about 135 degrees.

11. The laser level of claim 1, further comprising a first cage fixed to the housing and associated with the first laser projection plane, the first cage comprising a plurality of apertures, wherein the first laser projection plane is projected through at least one of the plurality of apertures.

12. A laser level comprising:
a housing; and
a core positioned within the housing, the core comprising:
a support;
a first arm extending from the support, the first arm configured to emit a first laser projection plane;
a second arm extending from the support, the second arm configured to emit a second laser projection plane;
a third arm extending from the support, the third arm configured to emit a third laser projection plane, wherein the third arm has a generally horizontal orientation relative to the support; and
a fourth arm extending in a generally horizontal orientation relative to the support, the fourth arm comprising a beam splitter;
wherein a first angle defined between the fourth arm and the third arm is from 90 degrees to 135 degrees.

13. The laser level of claim 12, wherein the first angle is from 120 degrees to 135 degrees.

14. The laser level of claim 12, wherein the first angle is from 90 degrees to 120 degrees.

15. The laser level of claim 12, wherein a second angle defined between the fourth arm and the second arm is from 90 degrees to 135 degrees.

16. The laser level of claim 12, wherein a second angle is defined between the fourth arm and the second arm, and wherein the second angle is the same as the first angle.

17. The laser level of claim 12, wherein the second arm is collinear with the fourth arm.

18. A laser level comprising:
a housing; and
a core positioned within the housing, the core comprising:
a support;
a first arm extending from the support, the first arm configured to emit a first laser projection plane;
a second arm extending from the support, the second arm configured to emit a second laser projection plane;
a third arm extending from the support, the third arm configured to emit a third laser projection plane; and
a fourth arm extending from the support, the fourth arm configured to emit a first laser point projection and a second laser point projection;
wherein a first angle is defined between the fourth arm and the third arm, wherein a second angle is defined between the fourth arm and the second arm, and wherein the second angle is the same as the first angle.

19. The laser level of claim 18, wherein the fourth arm has a first orientation relative to the support, and wherein the second arm and the third arm each extend in the first orientation and the first arm has a second orientation different than the first orientation.

20. The laser level of claim 18, further comprising:
a first cage fixed to the housing and associated with the first laser projection plane;
a second cage fixed to the housing and associated with the second laser projection plane; and
a third cage fixed to the housing and associated with the third laser projection plane;
wherein the first cage, the second cage, and the third cage each comprise a plurality of apertures through which the first laser projection plane, the second laser projection plane, and the third laser projection plane are projected respectively.
